(19) United States
(12) Patent Application Publication
(10) Pub. No.: US 2014/0318445 A1
(43) Pub. Date: Oct. 30, 2014

(54) SYSTEM FOR FABRICATING A CONDUCTIVE YARN FROM A PREFORMED YARN

(71) Applicant: Asiatic Fiber Corporation, Taipei City (TW)

(72) Inventor: Yao-Yuan Chang, Douliu City (TW)

(73) Assignee: Asiatic Fiber Corporation, Taipei City (TW)

(21) Appl. No.: 14/260,792

(22) Filed: Apr. 24, 2014

(30) Foreign Application Priority Data
Apr. 26, 2013 (TW) 102115101

(51) Int. Cl. H01B 13/30

(52) U.S. Cl. CPC H01B 13/30
USPC 118/60; 118/65

(57) ABSTRACT

A system for fabricating a conductive yarn from a preformed yarn includes a yarn spool, a soaking unit, a drying unit, and a yarn winder. The yarn spool is configured for winding and unwinding of the preformed yarn. The soaking unit is configured to receive a conductive slurry and to permit passage of a leading segment of the preformed yarn so that the preformed yarn is moistened with and absorbs the conductive slurry. The drying unit is configured to subject the preformed yarn that exits the soaking unit to a heat treatment to result in the conductive yarn. The yarn winder is configured to be connected to the leading segment of the preformed yarn and is configured for winding of the conductive yarn thereon.

### CROSS-REFERENCE TO RELATED APPLICATION

This application claims priority of Taiwanese Application No. 102115101, filed on Apr. 26, 2013.

### BACKGROUND OF THE INVENTION

1. Field of the Invention

The invention relates to a system for fabricating a yarn, more particularly to a system for fabricating a conductive yarn.

2. Description of the Related Art

Conductive fibers are widely utilized in anti-static, dustproof, or explosion-proof clothing used in the fields of semiconductor, electronic, medical engineering, bioengineering industries and the like. The conductive fibers may also be used in materials for shielding or absorbing electromagnetic wave, heat-generating components of electrothermal products, and glove structures for operating a capacitive touch panel.

Compared to conventional textile materials, the conductive fibers are hi-technology products in the textile industries. There are various known methods for producing the conductive fibers, such as metal fiber coating, surface treating, melt spinning, and the like.

For example, plasma chemical deposition has been used to coat metal on nylon fibers so as to produce conductive fibers. Silver is preferably used as the metal in view of good conductivity. Although a metal film may be uniformly formed by the plasma chemical deposition, the equipment for performing the plasma chemical deposition is expensive, and the process for the plasma chemical deposition is time-consuming.

Additionally, a known reduction method comprises the steps of: (a) placing oxidization fibers in a metal salt solution; and (b) placing the oxidization fibers after step (a) into a reducing agent in order to reduce metal ions to metal and to adhere the metal to the oxidization fibers. Although the equipment for implementing the reduction method is relatively simple, the precipitation rate and the homogeneity of the metal particles may not be controlled easily. Therefore, the electrical conduction property of fiber products manufactured by the aforesaid reduction method may not be satisfactory.

### SUMMARY OF THE INVENTION

The object of the present invention is to provide a system for fabricating a conductive yarn, which has high process efficiency and which may produce a conductive yarn with uniform electrical conduction property.

According to this invention, there is provided a system for fabricating a conductive yarn from a preformed yarn. The system comprises a yarn spool, a soaking unit, a drying unit, and a yarn winder arranged in sequence along a yarn processing path.

The yarn spool is configured for winding and unwinding of the preformed yarn.

The soaking unit is configured to receive a conductive slurry and to permit passage of a leading segment of the preformed yarn from the yarn spool therethrough so that the preformed yarn is moistened with and absorbs the conductive slurry as the preformed yarn passes through the soaking unit. The soaking unit includes at least one soaking tank. The soaking tank has a receiving space for receiving the conductive slurry, an entrance end for entry of the preformed yarn into the receiving space, and an exit end for exit of the preformed yarn absorbed with the conductive slurry from the receiving space.

The drying unit is configured to subject the preformed yarn that exits the soaking unit and that is absorbed with the conductive slurry to a heat treatment to result in the conductive yarn.

The yarn winder is configured to be connected to the leading segment of the preformed yarn and is configured for winding of the conductive yarn thereon.

Compared to the equipment for performing the aforesaid plasma chemical deposition, the system for fabricating a conductive yarn according to this invention has a relatively low equipment cost by virtue of cooperation between the soaking unit and the drying unit. Moreover, the conductive slurry may be absorbed on the preformed yarn continuously and uniformly using the system for fabricating a conductive yarn of this invention.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a first preferred embodiment of a system for fabricating a conductive yarn according to this invention;

FIG. 2 is a perspective view of a connecting tube included in the first preferred embodiment in an open state;

FIG. 3 is a perspective view of the connecting tube included in the first preferred embodiment in a closed state;

FIG. 4 is a cross-sectional view of the connecting tube in the open state;

FIG. 5 is a cross-sectional view of the connecting tube in the closed state;

FIG. 6 is a schematic view of a drying unit included in the first preferred embodiment; and

FIG. 7 is a schematic view illustrating a second preferred embodiment of a system for fabricating a conductive yarn according to this invention.

### DETAILED DESCRIPTION OF THE PREFERRED EMBODIMENTS

Before the present invention is described in greater detail, it should be noted that like elements are denoted by the same reference numerals throughout the disclosure.

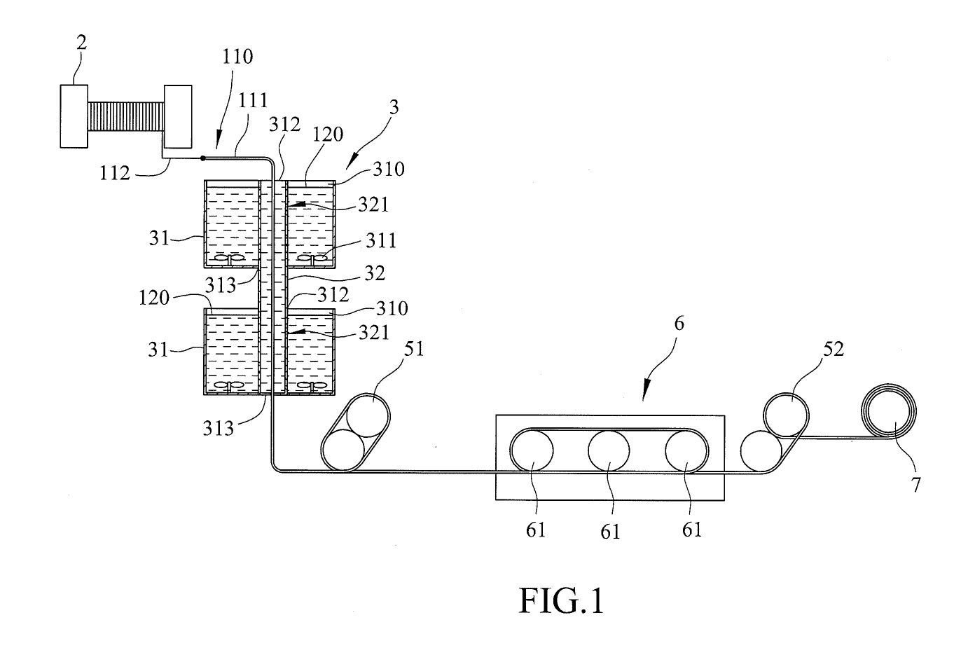

Referring to FIG. 1, a first preferred embodiment of a system for fabricating a conductive yarn from a preformed yarn 110 according to this invention includes a yarn spool 2, a soaking unit 3, a first guide roller assembly 51, a drying unit 6, a second guide roller assembly 52, and a yarn winder 7 arranged in sequence along a yarn processing path.

The yarn spool 2 is disposed at a start end of the yarn processing path and is configured for winding and unwinding of the preformed yarn 110. The preformed yarn 110 is wound on the yarn spool 2 and includes a leading segment 111 and a remaining segment 112 connected to the leading segment 111. One end of the remaining segment 112 is connected to one end of the leading segment 111. The other end of the leading segment 111 is connected to the yarn winder 7.

The leading segment 111 is used to pull the remaining segment 112 of the preformed yarn 110 to proceed along the yarn processing path. The leading segment 111 is preferably made of a material which is heat-resistant, wear-resistant, and water-proof so as to prevent the leading segment 111 from absorbing an excess amount of a conductive slurry 120 while passing through the conductive slurry 120 and to prevent the leading segment 111 from deforming or softening while passing through the drying unit 6. For example, the leading segment 111 used in this preferred embodiment is made of a Teflon-coated silicone wire. The remaining segment 112 of the preformed yarn 110 is preferably made of polyethylene terephthalate, polyamide, polypropylene, polyacrylic, or combinations thereof.

The soaking unit 3 is configured to receive the conductive slurry 120 and to permit passage of the leading segment 111 of the preformed yarn 110 from the yarn spool 2 therethrough so that the preformed yarn 110 is moistened with and absorbs the conductive slurry 120 as the preformed yarn 110 passes through the soaking unit 3. The soaking unit 3 includes at least one soaking tank 31. Two soaking tanks 31 spaced apart from each other are used in this preferred embodiment. Each of the soaking tanks 31 has a receiving space 310 for receiving the conductive slurry 120, an entrance end 312 for entry of the preformed yarn 110 into the receiving space 310, and an exit end 313 for exit of the preformed yarn 110 absorbed with the conductive slurry 120 from the receiving space 310. Each of the soaking tanks 31 further has at least two stirring members 311 disposed in the receiving space 310 and configured to stir the conductive slurry 120 in the receiving space 310.

The soaking unit 3 further includes a connecting tube 32 extending from the entrance end 312 of one of the soaking tanks 31 proximate to the yarn spool 2 to the exit end 313 of the other one of the soaking tanks 31 proximate to the drying unit 6. The connecting tube 32 is formed with a plurality of perforations 321 that permit the conductive slurry 120 in the receiving spaces 310 of the soaking tanks 31 to enter into the connecting tube 32.

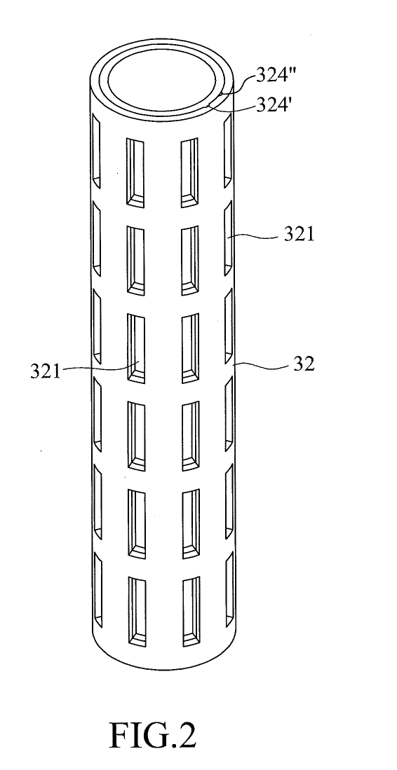

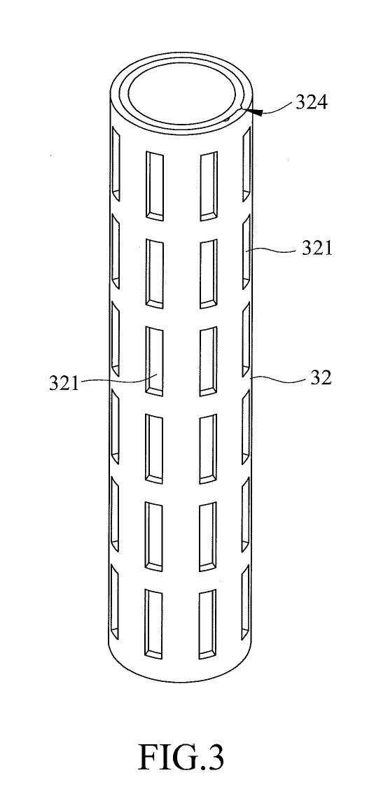

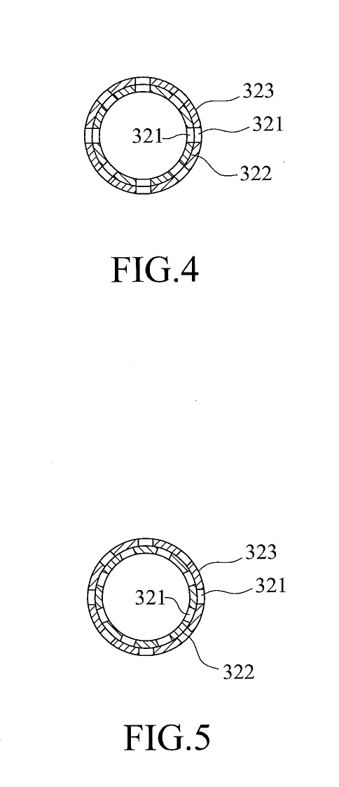

Referring to FIGS. 2, 3, 4, and 5, the connecting tube 32 includes an inner tube wall 322 extending along a tube axis and an outer tube wall 323 surrounding the inner tube wall 322. The perforations 321 include an array of first perforations 321 formed in the inner tube wall 322 and an array of second perforations 321 formed in the outer tube wall 323. One of the inner and outer tube walls 322, 323 is rotatable relative to the other of the inner and outer tube walls 322, 323 between an open state in which the first perforations 321 and the second perforations 321 are aligned with each other (see FIGS. 2 and 4) so as to permit flow of the conductive slurry 120 into the connecting tube 32 via the first and second perforations 321, and a closed state in which the first perforations 321 and the second perforations 321 are misaligned (see FIGS. 3 and 5) so as to block flow of the conductive slurry 120 into the connecting tube 32 via the first and second perforations 321.

The connecting tube 32 further includes an engaging member 324 having a male engaging part 324′ disposed at one of the inner and outer tube walls 322, 323, and a female engaging part 324″ disposed at the other of the inner and outer tube walls 322, 323. The male and female engaging parts 324′,324″ engage each other to arrest relative rotation between the inner and outer tube walls 322, 323 when said one of the inner and outer tube walls 322, 323 is at the open state.

Referring again to FIG. 1, the first guide roller assembly 51 is disposed between the soaking unit 3 and the drying unit 6, and the second guide roller assembly 52 is disposed between the drying unit 6 and the yarn winder 7. The guide roller assemblies 51, 52 permit the preformed yarn 110 to be transported smoothly along the yarn processing path.

The drying unit 6 is configured to subject the preformed yarn 110 that exits the soaking unit 3 and that is absorbed with the conductive slurry 120 to a heat treatment to result in the conductive yarn. The drying unit 6 includes a plurality of heating rollers 61 so as to provide a sufficient drying period for the heat treatment to obtain the conductive yarn.

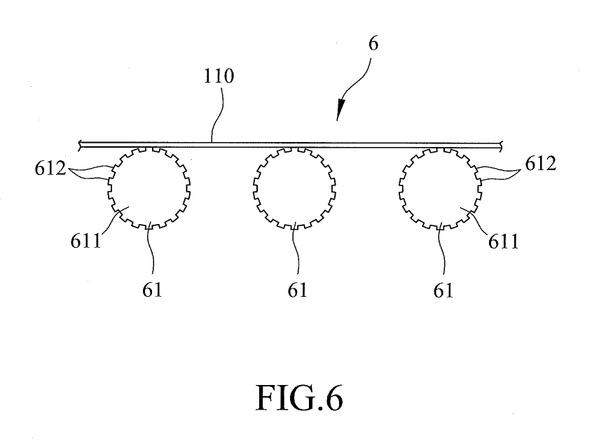

Referring to FIG. 6, each of the heating rollers 61 has a rotating axis perpendicular to the yarn processing path, and includes a central portion 611 and a plurality of protrusions 612 that protrude in radial outward directions from the central portion 611. The preformed yarn 110 abuts against the protrusions 612 of the heating rollers 61 when being pulled along the yarn processing path. Since the preformed yarn 110 only contacts the protrusions 612 of the heating rollers 61, the drying effect is enhanced and the conductive slurry 120 absorbed by the preformed yarn 110 may be prevented from adhering to the heating rollers 61.

Specifically, the heating rollers 61 are heated by a heater (not shown) so as to provide the heat for performing the heat treatment.

The yarn winder 7 is disposed at the end of the yarn processing path, is configured to be connected to the leading segment 111 of the preformed yarn 110, and is configured for winding of the conductive yarn thereon.

Referring again to FIG. 1, operation of the first preferred embodiment of the system for fabricating a conductive yarn of this invention will now be described.

First, the leading segment 111 of the preformed yarn 110 wound on the yarn spool 2 is passed through the connecting tube 32 of the soaking unit 3, is guided by the first guide roller assembly 51, is passed through the drying unit 6, is guided by the second guide roller assembly 52, and is finally connected to the yarn winder 7.

Next, the conductive slurry 120 is poured into the soaking tanks 31 while the connecting tube 32 is at the closed state (see FIGS. 3 and 5). The stirring members 311 are then activated so as to stir the conductive slurry 120 in the soaking tanks 31 for about 10-15 minutes.

After the heating rollers 61 of the drying unit 6 are pre-heated to a required temperature, the heating rollers 61 of the drying unit 6 and the yarn winder 7 are activated. The connecting tube 32 is rotated to the open state (see FIGS. 2 and 4) so that the first perforations 321 and the second perforations 321 are aligned with each other to permit flow of the conductive slurry 120 into the connecting tube 32 via the first and second perforations 321.

When the heating rollers 61 of the drying unit 6 and the yarn winder 7 are activated, the leading segment 111 is pulled by the yarn winder 7, and the preformed yarn 110 is moved along the yarn processing path. Specifically, the preformed yarn 110 enters into and passes through the connecting tube 32 and is moistened with the conductive slurry 120. After leaving the soaking unit 3, the preformed yarn 110 absorbed with the conductive slurry 120 is guided by the first guide roller assembly 51, and is transported into the drying unit 6 so as to be heated by the heating rollers 61 to thereby obtain the conductive yarn. The conductive yarn thus obtained is guided by the second guide roller assembly 52, and is then wound on the yarn winder 7.

The system for fabricating a conductive yarn of this invention has a relatively low equipment cost and a faster production rate as compared to the equipment for performing the aforesaid plasma chemical deposition. Moreover, the conductive slurry 120 may be absorbed on the preformed yarn 110 continuously and uniformly using the system for fabricating a conductive yarn of this invention.

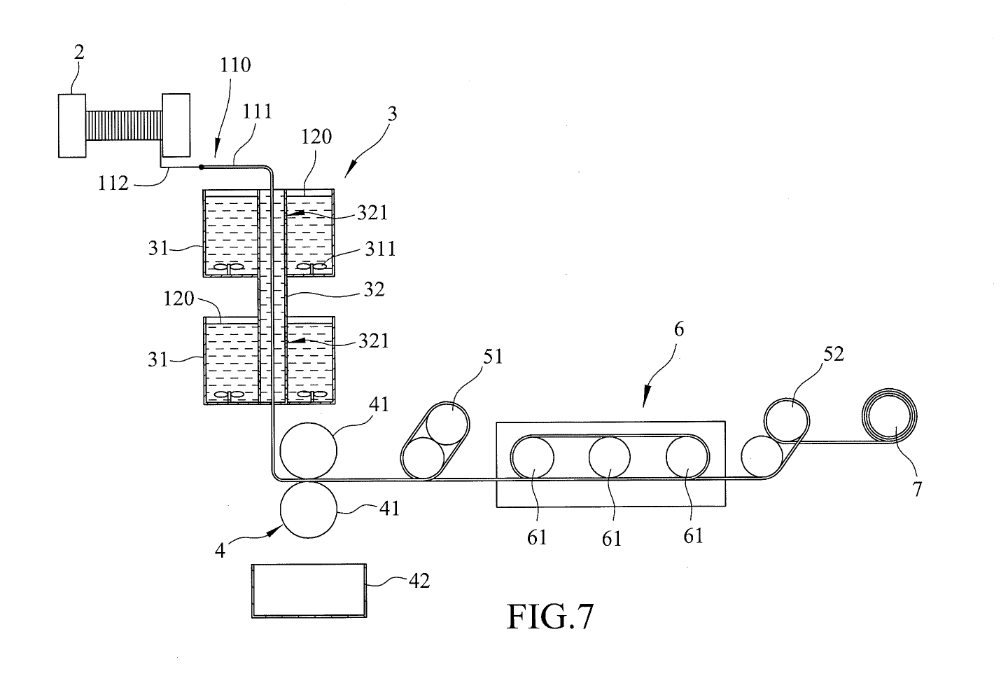

Referring to FIG. 7, a second preferred embodiment of a system for fabricating a conductive yarn from a preformed yarn 110 according to this invention is shown to be generally similar to the first preferred embodiment, the main difference residing in that a squeezing unit 4 is further included and is disposed between the soaking unit 3 and the drying unit 6. The first guide roller assembly 51 is disposed between the squeezing unit 4 and the drying unit 6. In this embodiment, the squeezing unit 4 includes two rollers 41 that abut against each other and that are configured to remove an excess amount of the conductive slurry 120 from the preformed yarn 110 that exits the soaking unit 3 and that is absorbed with the conductive slurry 120 when the preformed yarn 110 absorbed with the conductive slurry 120 passes between the rollers 41 before reaching the drying unit 6. Preferably, the squeezing unit 4 further includes a collecting tank 42 disposed below the rollers 41 to collect the excess amount of the conductive slurry 120 squeezed from the preformed yarn 110.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A system for fabricating a conductive yarn from a preformed yarn, said system comprising a yarn spool, a soaking unit, a drying unit and a yarn winder arranged in sequence along a yarn processing path, wherein:
said yarn spool is configured for winding and unwinding of the preformed yarn;
said soaking unit is configured to receive a conductive slurry and to permit passage of a leading segment of the preformed yarn from said yarn spool therethrough so that the preformed yarn is moistened with and absorbs the conductive slurry as the preformed yarn passes through said soaking unit, said soaking unit including at least one soaking tank, said soaking tank having a receiving space for receiving the conductive slurry, an entrance end for entry of the preformed yarn into said receiving space, and an exit end for exit of the preformed yarn absorbed with the conductive slurry from said receiving space;
said drying unit is configured to subject the preformed yarn that exits said soaking unit and that is absorbed with the conductive slurry to a heat treatment to result in the conductive yarn; and
said yarn winder is configured to be connected to the leading segment of the preformed yarn and is configured for winding of the conductive yarn thereon.

2. The system according to claim 1, wherein said soaking unit includes two of said soaking tanks spaced apart from each other, and a connecting tube extending from said entrance end of one of said soaking tanks proximate to said yarn spool to said exit end of the other one of said soaking tanks proximate to said drying unit, said connecting tube being formed with a plurality of perforations that permit the conductive slurry in said receiving spaces of said soaking tanks to enter into said connecting tube.

3. The system according to claim 2, wherein said connecting tube includes an inner tube wall extending along a tube axis and an outer tube wall surrounding said inner tube wall, said perforations including an array of first perforations formed in said inner tube wall and an array of second perforations formed in said outer tube wall, one of said inner and outer tube walls being rotatable relative to the other of said inner and outer tube walls between an open state in which said first perforations and said second perforations are aligned with each other so as to permit flow of the conductive slurry into said connecting tube via said first and second perforations, and a closed state in which said first perforations and said second perforations are misaligned so as to block flow of the conductive slurry into said connecting tube via said first and second perforations.

4. The system according to claim 3, wherein said connecting tube further includes an engaging member having a male engaging part disposed at one of said inner and outer tube walls, and a female engaging part disposed at the other of said inner and outer tube walls, said male and female engaging parts engaging each other to arrest relative rotation between said inner and outer tube walls when said one of said inner and outer tube walls is at the open state.

5. The system according to claim 1, wherein said soaking tank has a stirring member disposed in said receiving space and configured to stir the conductive slurry in said receiving space.

6. The system according to claim 1, wherein said drying unit includes at least one heating roller.

7. The system according to claim 6, wherein said heating roller includes a central portion and a plurality of protrusions that protrude in radial outward directions from said central portion.

8. The system according to claim 1, further comprising a squeezing unit disposed between said soaking unit and said drying unit, said squeezing unit including two rollers that abut against each other and that are configured to remove an excess amount of the conductive slurry from the preformed yarn that exits said soaking unit and that is absorbed with the conductive slurry when the preformed yarn absorbed with the conductive slurry passes between said rollers before reaching said drying unit.

9. The system according to claim 8, wherein said squeezing unit further includes a collecting tank disposed below said rollers to collect the excess amount of the conductive slurry squeezed from the preformed yarn.

10. The system according to claim 8, further comprising a guide roller assembly disposed between said squeezing unit and said drying unit.

11. The system according to claim 1, further comprising a guide roller assembly disposed between said drying unit and said yarn winder.
